(19) United States
(12) Patent Application Publication
(10) Pub. No.: US 2005/0105620 A1
(43) Pub. Date: May 19, 2005

(54) Motion vector detecting device and motion vector detecting program

(76) Inventor: Shigeru Fukushima, Yokohama-shi (JP)

Correspondence Address: NATH & ASSOCIATES, PLLC, Sixth Floor, 1030 15th Street, N.W., Washington, DC, 20005, US

(21) Appl. No.: 10/986,755

(22) Filed: Nov. 12, 2004

(30) Foreign Application Priority Data
Nov. 14, 2003 (JP) P2003-384599
Sep. 13, 2004 (JP) P2004-264850

(51) Int. Cl. H04B 1/66

(52) U.S. Cl. 375/240.16

(57) ABSTRACT

A search start point determination unit calculates error evaluation values of at least one of accumulation motion vectors which are motion vectors detected before detecting the motion vector of a coding target block and calculated motion vectors calculated from the accumulation motion vectors, and a hierarchical motion vector, detects a motion vector corresponding to the minimum error evaluation value of those error evaluation values as a first minimum error evaluation value point a, and determines the first minimum error evaluation value point a as a search start point. A motion vector search unit searches for all search points and the error evaluation values in a search range, for example, ±2 pixels around the search start point, in an image obtained from the reference image signal and the coding target signal. A motion vector determination/output unit detects a search point with the minimum error evaluation value as a second minimum error evaluation value point b and determines a vector, based on this second minimum error evaluation value point b, as a motion vector.

### BACKGROUND OF THE INVENTION

1. Field of the Invention

The present invention relates to a motion vector detecting device and a motion vector detecting program, and more particularly to a motion vector detecting device and a motion vector detecting program that detect a motion vector required for motion compensation when a moving image is compression-coded.

2. Description of the Related Art

For moving-image compression coding such as MPEG (Moving Picture Experts Group), motion compensation predictive coding is usually used to reduce the coding amount using the correlation between frames. In motion compensation predictive coding, a motion vector is required to indicate the relative positional relation between blocks (each block is a two-dimensional array composed of a predetermined number of pixels) of a coding target image and a block of a reference image. As the error evaluation value between blocks is smaller, this motion vector ensures a high precision of motion compensation prediction and increases the coding efficiency.

The error evaluation value described above is usually a value such as the value of a prediction error, represented by the sum of absolute differences or the sum of squares of differences between blocks using a block matching technique, or the value of a coding amount conversion based on the motion vector coding amount or the DCT (Discrete Cosine Transform) coefficient coding amount. The following describes a motion vector detecting device for reducing the error evaluation value.

One of motion vector detecting devices that can detect the smallest error evaluation value is a motion vector detecting device using the full search method. The full search method examines all candidate points as a round robin in a search range in a reference frame to detect a motion vector that gives the smallest error evaluation value. Although the full search method always detects a point that has the smallest error evaluation value in the search range, the method involves a huge amount of calculation because it examines all candidate points as a round robin in the search range.

To reduce the amount of calculation involved in the full search method, a motion vector detecting device using a hierarchical motion vector detecting method is provided. As shown in FIG. 5, this motion vector detecting device detects the motion vector 303 of a reduced image correspondence block 302 in a reduced image 301 with a reduced resolution and detects a hierarchical motion vector 306 corresponding to an original image 304 by decompressing the detected motion vector 303 based on the reduction ratio of the reduced image 301. In the original image 304, the device determines a motion vector search range 308 based on a search start point 307 with the point, pointed to by the hierarchical motion vector 306, as the search start point 307 and searches for a motion vector in this motion vector search range 308. The reduced image correspondence block 302 is a block included in the reduced image 301 and corresponding to a coding target block 305 in the original image 304.

A hierarchical motion vector can also be calculated by a pixel skipping search that does not create a reduced image but uses only selected pixels of a block of an original image for block matching. This pixel skipping search is also included in the hierarchical motion vector detecting method.

Because the hierarchical motion vector detecting device requires a small amount of calculation to detect the hierarchical motion vector 306 to be used as the search start point, the calculation amount is reduced. However, the problem with the hierarchical motion vector detecting device is that, when the hierarchical motion vector 306 indicating an approximate motion is different from an actual motion, the search takes time and the coding efficiency is decreased.

Another device for reducing the calculation amount of the full search method is a motion vector detecting device using the surrounding block reference method. This motion vector detecting device searches for a motion vector with at least one of the motion vectors of the surrounding blocks as the search start point. The surrounding blocks refer to the blocks which are adjacent to a coding target block 405, that is, blocks 401 to 404 and block 406 to 409 as shown in FIG. 6, and whose motion vector is already detected. Because the motion vector is detected generally in the order of blocks 401, 402, 403, . . . , 409, the blocks whose motion vector is already detected are blocks 401 to 404 when the device searches for the motion vector of the coding target block 405.

Because the motion vector detecting device using the surrounding block reference method uses an already-detected motion vector as the search start point, there is no need for calculating a new search start point and therefore the amount of calculation is reduced significantly. However, the problem with this method is that, when a new motion is generated that is not included in the surrounding blocks, the search takes long and the coding efficiency is reduced.

To solve the problem of the hierarchical motion vector detecting method and the problem of the surrounding block reference method, there is also a motion vector detecting device that combines the hierarchical motion vector detecting method and the surrounding block reference method. This motion vector detecting device examines the motion vector detected by the hierarchical motion vector detecting method and the motion vector detected by the surrounding block reference method and determines the motion vector, which has the smaller error evaluation value, as the motion vector.

Even when the problem with the hierarchical motion vector detecting method is generated, that is, even when a wrong motion vector is detected in a reduced image, this motion vector detecting device uses the motion vector detected by the surrounding block reference method to prevent the coding efficiency from being decreased. Also, even when the problem with the surrounding block reference method is generated, that is, even when a new motion is generated that is not included in the surrounding blocks, this motion vector detecting device uses the motion vector detected by the hierarchical motion vector detecting method to prevent the coding efficiency from being decreased. In this way, the combination of the hierarchical motion vector detecting method and the surrounding block reference method solves the problem with each motion vector detecting method.

However, the problem with this motion vector detecting device is an increase in the calculation amount because the calculation amount is the sum of the calculation method of the hierarchical motion vector detecting method and that of the surrounding block reference method.

To reduce the calculation amount of the motion vector detecting device that combines the hierarchical motion vector detecting method and the surrounding block reference method, a motion vector detecting device with consideration for MPEG picture types is conventionally known. This motion vector detecting device prevents (or limits) a reference to surrounding blocks when the image is a B picture that is a bi-directionally predictive-coded picture (for example, see Japanese Patent Laid-Open Publication No. Hei 8-265773).

The following describes the configuration of this conventional motion vector detecting device with reference to FIG. 1. FIG. 1 is a block diagram showing an example of the conventional motion vector detecting device. As shown in FIG. 1, this conventional motion vector detecting device comprises a reference image memory 101, a coding target image memory 102, a hierarchical MV calculation unit 103, a surrounding MV memory 104, a surrounding MV supply control unit 105, a motion vector search unit 106, a search point/error evaluation value memory 107, and a motion vector determination/output unit 108.

The reference image memory 101 stores received reference image signals. The coding target image memory 102 stores received coding target image signals.

The hierarchical MV calculation unit 103 creates a reduced image with a resolution lower than that of the original image from the reference image signal and the coding target image signal. After detecting the motion vector (MV) of the corresponding coding target block in that reduced image, the hierarchical MV calculation unit 103 decompresses the detected motion vector based on the reduction ratio of the reduced image to calculate the motion vector corresponding to the original image as a hierarchical MV. This hierarchical MV is supplied to the motion vector search unit 106. A hierarchical motion vector (hierarchical MV) can also be calculated by a pixel skipping search that does not create a reduced image but uses only the selected pixels of a block of an original image for block matching.

The surrounding MV memory 104 stores the surrounding MVs of a coding target block. The surrounding MV supply control unit 105, which supplies the surrounding MVs of a coding target block to the motion vector search unit 106, controls the supply of surrounding MVs considering the MPEG picture types. For example, the surrounding MV supply control unit 105 inhibits (or limits) the supply of surrounding MVs when the picture is a B picture to suppress an increase in the amount of calculation of B pictures.

The operation of the surrounding MV supply control unit 105 will be describe below with reference to the flowchart in FIG. 2. First, the surrounding MV supply control unit 105 checks the picture type signal, which indicates the picture type of a received coding image, to determine if the picture type signal indicates a B picture (step S21). If the picture type signal indicates a B picture, the surrounding MV supply control unit 105 does not supply, or limits the supply of, the surrounding MVs from the surrounding MV memory 104 to the motion vector search unit 106 (step S22). If the picture type signal does not indicates a B picture (a P picture that is an inter-frame forward predictive coded picture), the surrounding MV supply control unit 105 supplies all surrounding MVs stored in the surrounding MV memory 104 to the motion vector search unit 106 (step S23).

Returning to FIG. 1 again, the motion vector search unit 106 receives the hierarchical MV from the hierarchical MV calculation unit 103 as the search start point and, at the same time, receives surrounding MVs from the surrounding MV supply control unit 105 as the search start point. Then, the motion vector search unit 106 performs the search for each of the search start points, for example, for ±2 pixels around each search start point, and stores the search point and the error evaluation value into the search point/error evaluation value memory 107.

The motion vector determination/output unit 108 detects the minimum error evaluation value point b from the motion vector search points, determines the vector based on the minimum error evaluation value point b as the motion vector, outputs the determined motion vector from an output terminal 109 to an external device and, at the same time, stores it in the surrounding MV memory 104. In detecting a motion vector by combining the hierarchical motion vector detecting method and the surrounding block reference method, this conventional motion vector detecting device checks if the MPEG picture type is a B picture and, if so, inhibits (or limits) the reference to the surrounding blocks in order to suppress an increase in the calculation amount of the B picture.

However, when the picture type is a P picture, the motion vector search unit 106 of the conventional motion vector detecting device shown in FIG. 1 searches for a motion vector using the hierarchical MV and surrounding MVs as the search start point. Because there is only one hierarchical MV but there are a maximum of four surrounding MVs, the hierarchical MV and the surrounding MVs (a total of five) are used as the search start point and therefore the calculation amount is increased.

When the coding target image is a B picture, this motion vector detecting device inhibits the supply of the surrounding MVs and uses only the hierarchical MV as the search start point to suppress an increase in the calculation amount. In this case, however, even when a better motion vector can be found by the surrounding block reference method rather than by the hierarchical motion vector detection method, this motion vector detecting device detects a motion vector using the hierarchical motion vector detecting method and therefore the coding efficiency is decreased.

### SUMMARY OF THE INVENTION

In view of the foregoing, it is an object of the present invention to provide a motion vector detecting device and a motion vector detecting program that can reduce the calculation amount of a P picture and a B picture without decreasing the coding efficiency by examining a hierarchical MV and accumulation MVs to detect an MV that gives the minimum error evaluation value point and by searching for a motion vector with only the minimum error evaluation value point as the search start point.

It is another object of the present invention to provide a simple-to-configure motion vector detecting device that can further increase the coding efficiency of all picture types (P picture and B picture) but that does not depend on the picture type.

To achieve the above object, there is provided a motion vector detecting device for detecting a motion vector so that an error evaluation value between a block of a coding target image and a block of a reference image becomes smaller, the motion vector being required for motion compensation predictive coding of the coding target image that is a moving image, the motion vector indicating a relative positional relation between the blocks, each of the blocks being a two-dimensional pixel aggregate composed of a predetermined number of pixels, the motion vector detecting device comprising: a hierarchical motion vector calculation unit that detects a motion vector indicating a relative positional relation between the coding target block of the coding target image and the block of the reference image in an image, created from the coding target image and the reference image and having a resolution lower than that of an original image, and decompresses the detected motion vector based on a reduction in the resolution for calculating a hierarchical motion vector; a search start point determination unit that calculates error evaluation values of at least one of an accumulation motion vector which is a motion vector detected before detecting the motion vector of the coding target block and a calculated motion vector calculated from the accumulation motion vector, and the hierarchical motion vector calculated by the hierarchical motion vector calculation unit, detects a motion vector corresponding to a minimum error evaluation value of the error evaluation values as a first minimum error evaluation value point, and determines the first minimum error evaluation value point as a search start point; a motion vector search unit that searches for search points in a search range, which is in the reference image and is determined based on the search start point of the coding target block, and error evaluation values corresponding to the search points; and a motion vector determination/output unit that detects a search point, which is one of the search points searched for by the motion vector search unit and whose error evaluation value searched for by the motion vector search unit is the minimum, as a second minimum error evaluation value point, determines a vector based on the second minimum error evaluation value point as the motion vector indicating the relative positional relation between the blocks of the coding target image and the reference image, and outputs the motion vector.

The motion vector detecting device according to the present invention calculates error evaluation values of at least one of an accumulation motion vector which is a motion vector detected before detecting the motion vector of a coding target block and a calculated motion vector calculated from the accumulation motion vector, and a hierarchical motion vector, detects a motion vector corresponding to the minimum error evaluation value of those error evaluation values as a first minimum error evaluation value point, determines the first minimum error evaluation value point as the search start point, and detects a final motion vector from the search points in the search range, determined by the search start point in the coding target block, in the reference image and the error evaluation values of the search points. Therefore, this device eliminates a wasteful search. In addition, as compared with a conventional device that searches for a motion vector for each of a hierarchical motion vector and surrounding motion vectors that are motion vectors of surrounding blocks using those motion vectors as the search start point, the motion vector detecting device according to the present invention can reduce the amount of calculation significantly and, at the same time, eliminates a wasteful search by searching for a point with a high possibility of the minimum error evaluation value.

In addition, the motion vector detecting device according to the present invention reduces the amount of calculation for a P picture as compared with that of a conventional device that checks the MPEG picture type and, if the picture is a B picture, inhibits (or limits) a reference to accumulation motion vectors such as surrounding blocks, and thus suppresses an increase in the amount of calculation for a B picture. Even when the picture is a B picture, the motion vector detecting device according to the present invention can reference surrounding blocks. In addition, the device can detect a motion vector regardless of whether the picture is a P picture or a B picture with no need for checking the MPEG picture type, thus making the configuration of the device simple.

In a preferred embodiment of the present invention, the hierarchical motion vector calculation unit creates a reduced image, whose resolution is reduced from that of the original image, from the coding target image and the reference image, detects the motion vector indicating the relative positional relation between the coding target block and the reference image block corresponding with each other in the reduced image, and decompresses the detected motion vector based on a reduction ratio of the reduced image for calculating a motion vector, which corresponds to the original image, as the hierarchical motion vector.

In a preferred embodiment of the present invention, the search start point determination unit calculates an error evaluation value of a motion vector of a surrounding block and the error evaluation value of the hierarchical motion vector calculated by the hierarchical motion vector calculation unit, detects a motion vector corresponding to a minimum of the error evaluation values as the first minimum error evaluation value point, and determines the first minimum error evaluation value point as the search start point, the motion vector of the surrounding block being used as the accumulation motion vector, the surrounding block being adjacent to the coding target block to be coded, the motion vector of the surrounding block being already calculated.

In a preferred embodiment of the present invention, the search start point determination unit calculates the error evaluation value of at least one of a reference image motion vector of a block located spatially at the same position in the reference image as that of the coding target block of the coding target image, a multi-reference motion vector calculated based on an already-detected motion vector of a reference image when there are a plurality of reference images, and a predictive motion vector predicted based on a motion vector of a surrounding block which is adjacent to the coding target block and whose motion vector is already detected and the error evaluation value of the hierarchical motion vector calculated by the hierarchical motion vector calculation unit, detects a motion vector corresponding to a minimum of the error evaluation values as the first minimum error evaluation value point, and determines the first minimum error evaluation value point as the search start point, the calculated motion vector calculated based on the accumulation motion vector including at least one of the reference image motion vector, the multi-reference motion vector, and the predictive motion vector.

In this embodiment, not only the surrounding motion vector that is accumulation motion vector but also a motion vector calculated from the accumulation vector is used. The motion vector calculated from the accumulation vector include at least one of a reference image motion vector of a block within the reference image that is in the position corresponding to a coding target block, a multi-reference motion vector calculated based on an already-detected motion vector of a reference image when there are a plurality of reference images, and a predictive motion vector (PMV). Therefore, the device according to the present invention has more candidates for search start points, uses a smaller error evaluation value of the search start point, and further increases the coding efficiency.

In a preferred embodiment of the present invention, the motion vector search unit performs a tracking search which, with a search point in the center of a search pattern within the search range as the search start point determined by the search start point determination unit, calculates the error evaluation values between the coding target block and the reference image block in the corresponding position for the search start point and each of a predetermined number of a plurality of surrounding search points and continues the search for a motion vector by moving the center of the search pattern to a surrounding search point whose error evaluation value is smaller until a search point whose calculated error evaluation value is smallest becomes the search point in the center of the search pattern.

As described above, when using the tracking search as the motion vector search beginning at the search start point, the motion vector detecting device according to the present invention uses one of a hierarchical motion vector and an accumulation motion vector, whichever gives the minimum error evaluation value point, to reduce the error evaluation value of the search start point. Therefore, the device further enhances the effect of the tracking search that provides a higher coding efficiency and requires a smaller amount of calculation as the error evaluation value of the search start point is smaller.

To achieve the above object, there is provided a motion vector detecting program for causing a computer to detect a motion vector so that an error evaluation value between a block of a coding target image and a block of a reference image becomes smaller, the motion vector being required for motion compensation predictive coding of the coding target image that is a moving image, the motion vector indicating a relative positional relation between the blocks, each of the blocks being a two-dimensional pixel aggregate composed of a predetermined number of pixels, the motion vector detecting program causing the computer to execute: a hierarchical motion vector calculation step that detects a motion vector indicating a relative positional relation between the coding target block of the coding target image and the block of the reference image in an image, created from the coding target image and the reference image and having a resolution lower than that of an original image, and decompresses the detected motion vector based on a reduction in the resolution for calculating a hierarchical motion vector; a search start point determination step that calculates error evaluation values of at least one of an accumulation motion vector and a calculated motion vector calculated from the accumulation motion vector, and the hierarchical motion vector calculated by the hierarchical motion vector calculation step, detects a motion vector corresponding to a minimum error evaluation value of the error evaluation values as a first minimum error evaluation value point, and determines the first minimum error evaluation value point as a search start point, the accumulation motion vector being a motion vector detected before detecting the motion vector of the coding target block; a motion vector search step that searches for search points in a search range, which is in the reference image and is determined based on the search start point of the coding target block, and error evaluation values corresponding to the search points; and a motion vector determination/output step that detects a search point, which is one of the search points searched for by the motion vector search step and whose error evaluation value searched for by the motion vector search step is the minimum, as a second minimum error evaluation value point, determines a vector based on the second minimum error evaluation value point as the motion vector indicating the relative positional relation between the blocks of the coding target image and the reference image, and outputs the motion vector.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a block diagram showing an example of a conventional motion vector detecting device;

FIG. 2 is a flowchart showing the operation of the surrounding MV supply control unit shown in FIG. 1;

FIG. 3 is a block diagram showing one embodiment of a motion vector detecting device according to the present invention;

FIG. 4 is a flowchart showing the operation of the search start point determination unit shown in FIG. 3;

FIG. 5 is a diagram showing an example of the hierarchical MV calculation method;

FIG. 6 is a diagram showing surrounding blocks used in the surrounding block reference method;

FIGS. 7A and 7B are diagrams showing a reference image MV;

FIG. 8 is a diagram showing the calculation of a reference image MV;

FIG. 9 is a diagram showing the calculation of a multi-reference MV;

FIG. 10 is a diagram showing the calculation of a PMV;

FIGS. 11A and 11B are diagrams showing an example of a motion vector search; and

FIG. 12 is a diagram showing an example of the hierarchical MV calculation method through a pixel skipping search.

### DESCRIPTION OF THE PREFERRED EMBODIMENTS

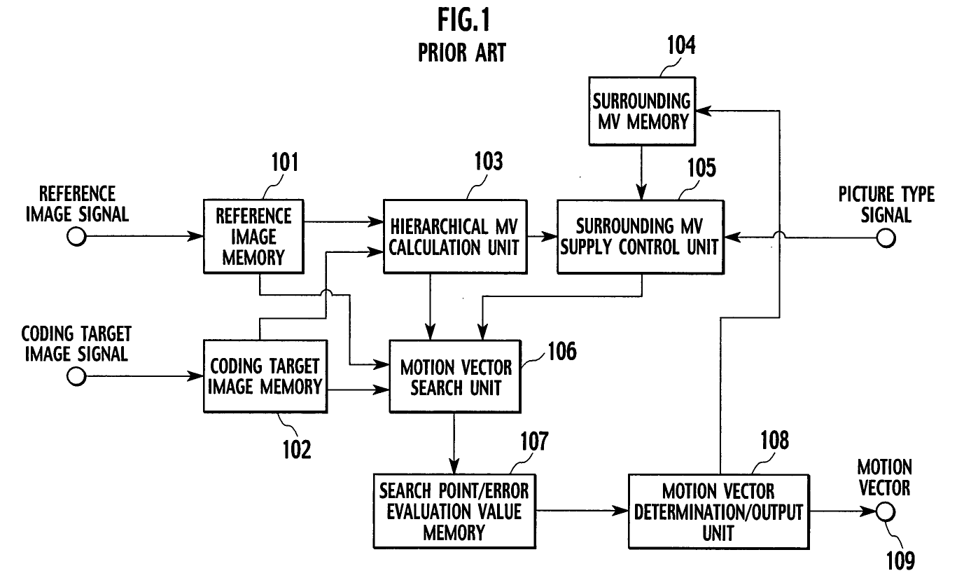

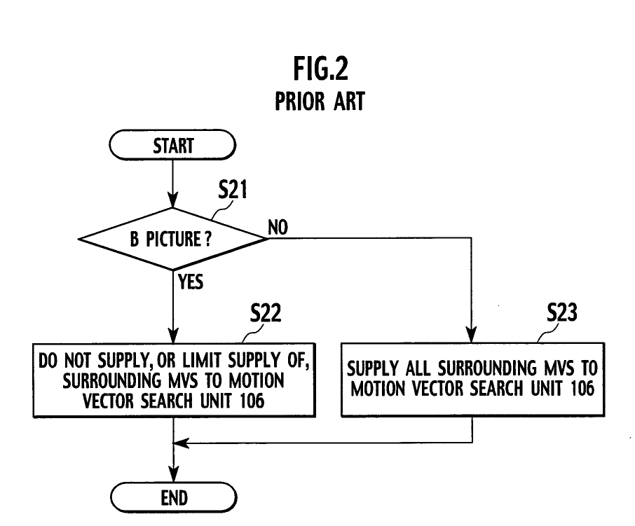

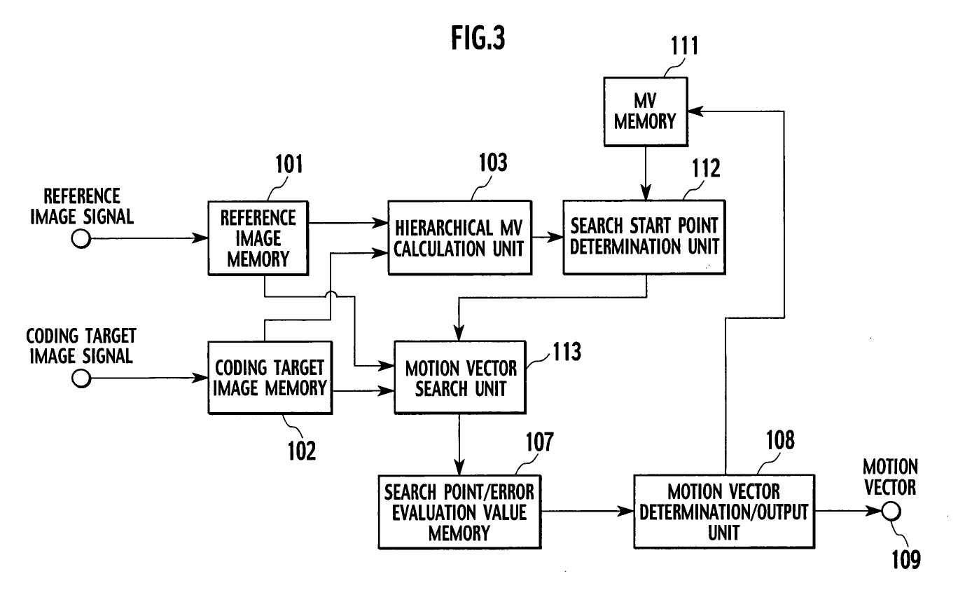

Next, an embodiment according to the present invention will be described below with reference to the drawings. FIG. 3 is a block diagram of one embodiment of a motion vector detecting device according to the present invention. In the drawings, the same reference numerals denote the same structural elements shown in FIG. 1.

This embodiment comprises a reference image memory 101, a coding target image memory 102, a hierarchical MV calculation unit 103, a search point/error evaluation value memory 107, a motion vector determination/output unit 108, an MV memory 111, a search start point determination unit 112, and a motion vector search unit 113. This embodiment is different from the conventional motion vector detecting device shown in FIG. 1 in that the MV memory 111 is provided instead of the surrounding MV memory 104, in that the search start point determination unit 112 is provided instead of the surrounding MV supply control unit 105, and in that the motion vector search unit 113 searches for a motion vector based on a search start point determined by the search start point determination unit 112.

Next, the operation of this embodiment will be described. A coding target image signal, which is a moving image signal to be compression coded by the MPEG method, is supplied to the coding target image memory 102 and stored therein. A reference image signal is also supplied to the reference image memory 101 and stored therein. This reference image signal may be either an image signal before being locally decoded or an image signal after being locally decoded.

The hierarchical MV calculation unit 103 uses the reference image signal read from the reference image memory 101 and the coding target image signal read from the coding target image memory 102 to create a reduced image with a resolution lower than that of the original image, detects the motion vector (MV) of the corresponding coding target block in that reduced image, decompresses the detected motion vector based on the reduction ratio of the reduced image, and calculates a motion vector corresponding to the original image for use as a hierarchical MV. This hierarchical MV is supplied to the search start point determination unit 112.

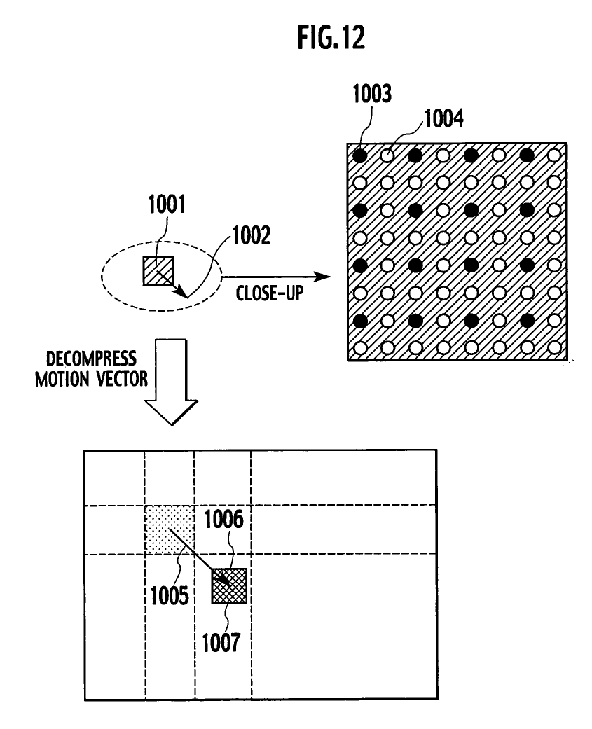

As described above, a hierarchical MV can also be calculated by a pixel skipping search that does not create a reduced image but uses only the selected pixels of a target block of an original image for block matching. In this pixel skipping search, a motion vector 1002 of a pixel skipping block 1001 of an original image is first detected in FIG. 12. In this figure, the pixel skipping block 1001 is composed of selected pixels 1003 indicated by black circles and other pixels 1004 indicated by white circles. The pixel skipping block 1001, which is an image with a resolution lower than that of the original image, is created using only the selected pixels 1003 for block matching with the other pixels 1004 removed. From this pixel skipping block 1001, the motion vector 1002 between the coding target block and the reference image clock is detected.

Then, this motion vector 1002 is decompressed based on the pixel skipping ratio (corresponding to the reduction ratio in FIG. 5 described above) that is a ratio of the other pixels 1004 to the selected pixels 1003 described above. By doing so, a motion vector, which corresponds to the original image containing all pixels and which is indicated by the numeral 1005 in FIG. 12, is determined as the hierarchical MV.

On the other hand, the MV memory 111 stores accumulation MVs that are output from the motion vector determination/output unit 108 and are candidates for the search start point of the coding target block. An accumulation MV is, for example, the motion vector (surrounding MV) of a surrounding block which is adjacent to the coding target block and for which the motion vector is already detected. The search start point determination unit 112 determines the search start point from at least one of the hierarchical MV and accumulation MVs, which are described above, and an MV calculated from accumulation MVs. As will be described later, an MV calculated from accumulation MVs is an MV of a block located spatially at the same position in the reference image as that of the coding target block of the coding target image (this MV is called a reference image MV), a motion vector calculated based on an already-detected motion vector of a reference image when there are a plurality of reference images (this MV is called a multi-reference MV), and a predictive motion vector (PMV).

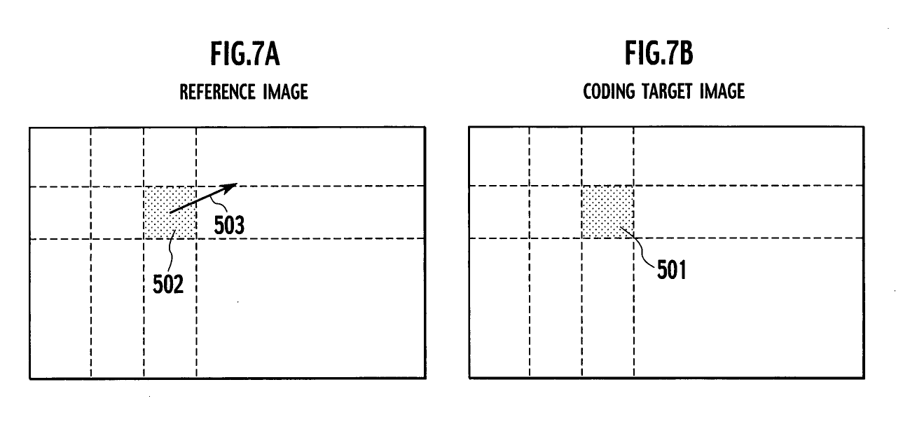

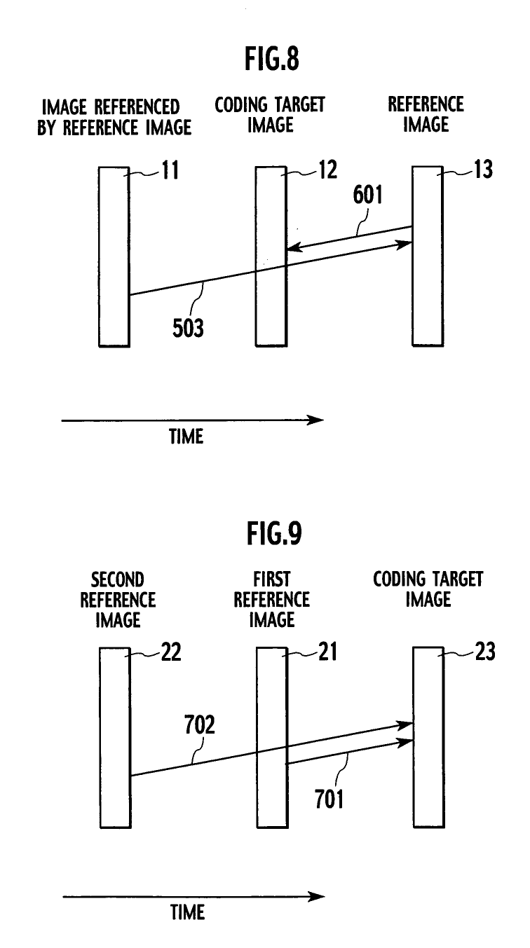

First, a reference image MV, one of the above-described MVs calculated from accumulated MVs, will be described with reference to FIG. 7. A motion vector 503 of a block 502 is a reference image MV, wherein the block 502 shown in FIG. 7A corresponds to a coding target block 501 of a coding target image shown in FIG. 7B and is located in the reference image in the position corresponding to the coding target block 501. Although a reference image MV is considered a motion vector described above, it is usually calculated from an accumulation motion vector as shown in FIG. 8 considering the frame-to-frame distance.

For example, assume that the frame number of an image 11 referenced by a reference image 13 is 1, the frame number of a coding target image 12 is 2, and the frame number of the reference image 13 is 3 in order of the display as shown in FIG. 8 and that the coordinates of the motion vector 503 of the reference image 13 are (2, −2). Because the reference image MV can be obtained by decompressing the motion vector 503 of the reference image, which is an accumulation motion vector, −½ times (={(frame number of coding target image 12)−(frame number of reference image 13)}/{(frame number of reference image 13)−(frame number of reference-image referencing image 11)}=(2−3)/(3−1)), the coordinates of a reference image MV 601 is (−1, 1). A reference image MV is present except when the picture is an I picture.

Next, the following describes the multi-reference MV described above with reference to FIG. 9. Assume that the two reference images of a coding target image 23 are a first reference image 21 and a second reference image 22 as shown in FIG. 9 and that a motion vector 701 of the first reference image 21 is already detected. In this case, the multi-reference MV is a motion vector 702 obtained by decompressing the motion vector 701, which is an accumulation vector and which is the motion vector of the coding target block of the coding target image with respect to the reference image 21, considering the inter-frame distance between the coding target image and the reference image.

For example, assume that the frame number of the second reference image 22 is 1, the frame number of the first reference image 21 is 2, and the frame number of the coding target image 23 is 3 in order of the display as shown in FIG. 9 and that the coordinates of the motion vector 701 with respect to the first reference image 21 are (−3, 1). The coordinates of the multi-reference MV (−6, 2) can be calculated by decompressing the motion vector 701 with respect to the first reference image 21 two times (={(frame number of coding target image 23)−(frame number of second reference image 22)}/{(frame number of coding target image 23)−(frame number of first reference image 21)}=(3−1)/(3−2)).

The motion vector 701 of the reference image 21 can also be used as a multi-reference MV without changing the scale of the motion vector with no consideration for the inter-frame distance. A multi-reference MV is present when an attempt is made to detect a motion vector for the second and the following reference images when there are a plurality of reference images.

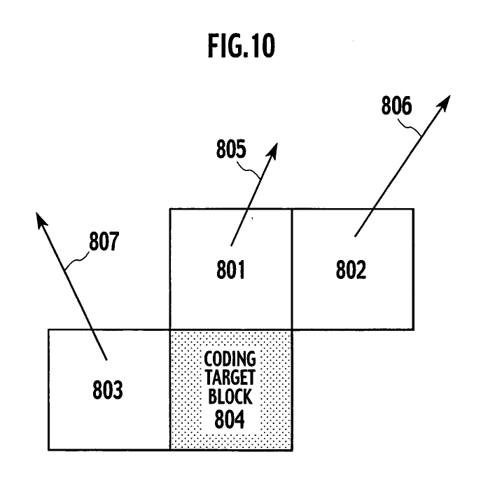

Next, the following describes the PMV described above. A PMV is used for calculating a differential motion vector (DMV) for coding a motion vector, and the DMV is reduced and the motion vector coding amount is reduced as the motion vector becomes closer to the PMV. The calculation method for a PMV is different according to the coding standard. With reference to FIG. 10, the following describes an example of the calculation method in which the median of the surrounding MVs is used as the PMV. Assume that the surrounding blocks of a coding target block 804 are blocks 801, 802, and 803 and that the motion vectors corresponding to those blocks are motion vectors 805, 806, and 807. When the coordinates of the motion vector 805 are (2, −3), the coordinates of the motion vector 806 are (4, −4), and the coordinates of the motion vector 807 are (−2, −5), the PMV is (2, −4) because the median of the x components is 2 and the median of the y components is −4. When the PMV is the median of the surrounding MVs in this way, a new MV not included in the surrounding MVs can be calculated as the PMV.

As described above, not only the surrounding MVs that are accumulation MVs detected before detecting the motion vector of a coding target block but also the MVs calculated from the accumulation MVs are used such as the MV of a block within the reference image that is in the position corresponding to the coding target block (that is, a reference image MV), a motion vector calculated based on an already-detected motion vector of a reference image when there are a plurality of reference images (that is, a multi-reference MV), and a predictive motion vector (PMV). Therefore, as compared with a conventional device that uses only surrounding MVs, the device according to the present invention has more candidates for search start points. This means that the device becomes to have a smaller error evaluation value of the search start point and further increases the coding efficiency.

Returning again to FIG. 3, the search start point determination unit 112 detects a MV, which gives the minimum error evaluation value point a, from at least one of the hierarchical MV obtained from the hierarchical MV calculation unit 103, the accumulation MVs obtained from the MV memory 111, and calculated MVs calculated from the accumulation MVs and then supplies only the minimum error evaluation value point a to the motion vector search unit 113 as the search start point.

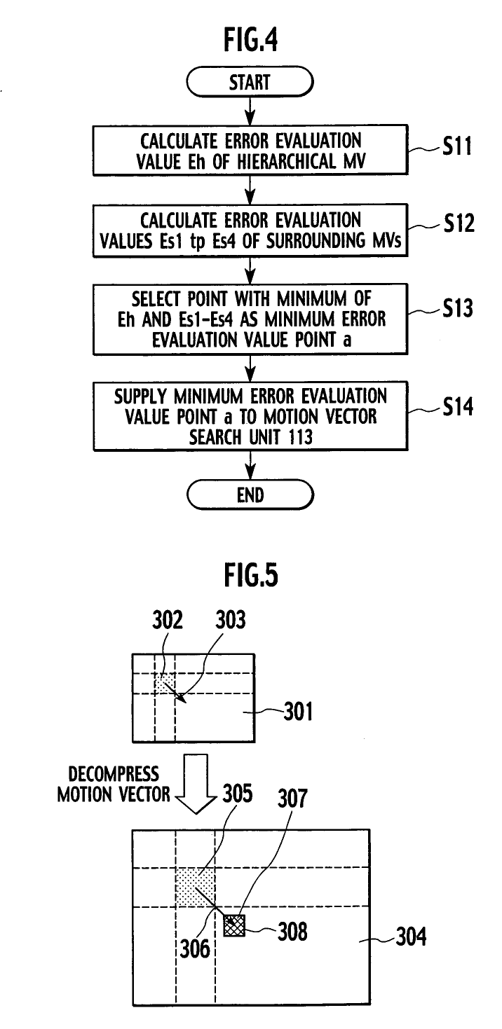

Here, the following describes the operation of the search start point determination unit 112 more in detail using the flowchart in FIG. 4. In the example, only surrounding MVs are stored as accumulation MVs for simplicity. First, the error evaluation value Eh of the hierarchical MV obtained by the hierarchical MV calculation unit 103 is calculated based, for example, on the sum of absolute differences between blocks (step S11). The sum of absolute differences is the total (sum) calculated by sequentially adding the absolute values of differences between the pixels of the coding target block of the coding target image signal and the corresponding pixels of the reference block of the reference image signal.

Next, the error evaluation values Es1-Es4 of the four surrounding MVs are calculated using the sum of absolute differences between blocks as for the error evaluation value Eh described above (step S12). The hierarchical MV and the surrounding MVs indicate the relative position of the coding target block of the coding target image signal and the reference block of the reference image signal.

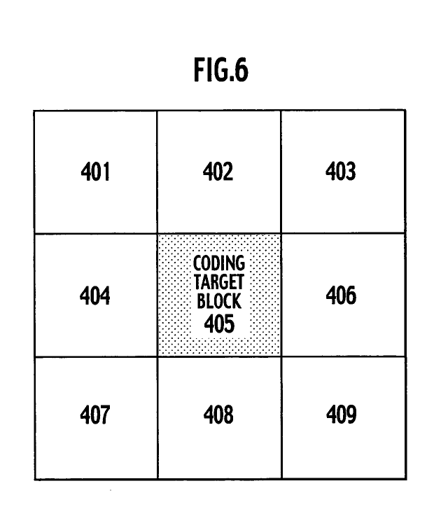

Although there are four surrounding MVs in the example described above, the error evaluation values are calculated only for surrounding MVs that are present when there are not four surrounding MVs, for example, when the image is at an end. Although the surrounding MVs are defined as the MVs 401 to 404 in FIG. 6, the surrounding MVs are not limited to this definition. For example, the surrounding MVs may be MVs 402 to 404.

Next, the search start point determination unit 112 selects the point (motion vector), which has the minimum error evaluation value, from the calculated error evaluation values Eh and Es1-Es4 as the minimum error evaluation value point a (step S13). Lastly, the search start point determination unit 112 determines the minimum error evaluation value point a as the search start point and supplies it to the motion vector search unit 113 (step S14).

In the above description, the search start point determination unit 112 determines the point, which has the minimum error evaluation value of the hierarchical MV and surrounding MVs, as the minimum error evaluation value point a. Actually, however, the search start point determination unit 112 is configured in such a way that the minimum error evaluation value point a is selected from an error evaluation value of at least one MV of the surrounding MVs that are accumulation MVs and the calculated MVs (reference image MV, multi-reference-MV, and PMV described above) calculated from the accumulation MVs, and the error evaluation value Eh of the hierarchical MV. Therefore, when it is determined in advance that the minimum error evaluation value point is found by calculating at least one of calculated MVs, such as the reference image MV, multi-reference MV, and PMV, from the accumulation MVs read from the MV memory 111, the search start point determination unit 112 comprises the calculation function for calculating the calculated MVs and the function for calculating the error evaluation value Es of the calculated MV, for example, based on the sum of absolute differences between blocks as for the error evaluation value Eh described above.

Returning again to FIG. 3, the motion vector search unit 113 receives the search start point (minimum error evaluation value point a) from the search start point determination unit 112 and also receives the reference image signal from the reference image memory 101 and the coding target image signal from the coding target image memory 102. The motion vector search unit 113 then searches for all points (pixels) in the search range, which is ±2 pixels around the search start point (minimum error evaluation value point a) in the reference image of the reference image signal, obtains search points and, at the same time, calculates the error evaluation values of the search points based, for example, on the sum of absolute differences between blocks. The motion vector search unit 113 associates the search points with the calculated error evaluation values and stores them in the search point/error evaluation value memory 107.

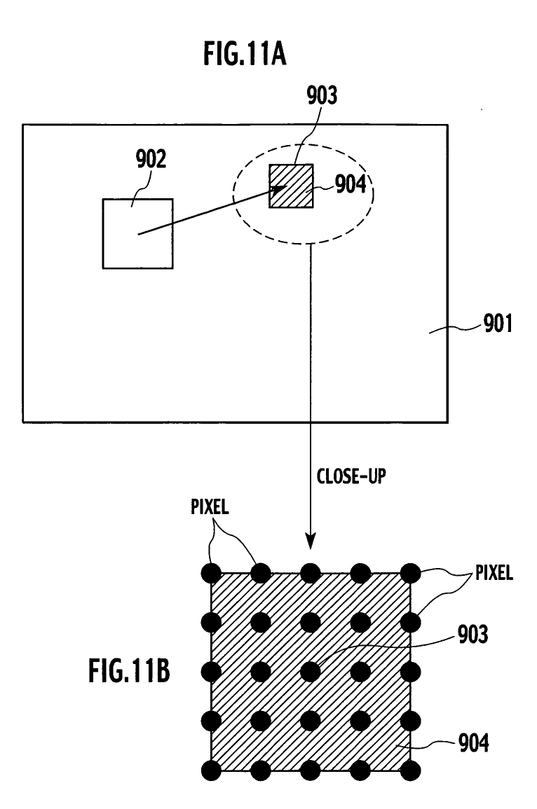

The motion vector search operation performed by the motion vector search unit 113 will be described more in detail. The motion vector search unit 113 searches for all points (pixels) indicated by black circles in a search range 904, which is ±2 pixels around a search start point (minimum error evaluation value point a) 903 as shown in FIG. 11B, based on the search start point 903 (minimum error evaluation value point a) of a coding target block 902 of the coding target image signal, that is included in a reference image 901 described above as shown in FIG. 11A. After searching for the search points, the motion vector search unit 113 calculates the error evaluation values for the search points.

Although the search method for searching for all search points in the search range, which is ±2 pixels around the search start point, is described in the example described above, any search method for searching a predetermined search range defined based on the search start point can be used and the predetermined search range can be determined arbitrarily. For example, the tracking search beginning at the search start point disclosed in the known patent document (Japanese Patent Laid-Open Publication No. 2003-87799) may be used.

The tracking search method is a method for searching for a motion vector by moving the center of the search to a point with a smaller error evaluation value. For example, when moving the search point from the search origin according to a predetermined search pattern, the sum of absolute differences between the data of the pixels in the coding target block of the coding target image and the data of the pixels in the block of the reference image that is in the corresponding position is calculated for the search point in the center of the search pattern and for each of a plurality of search points around the search point in the center. When the search point, whose calculated sum of absolute differences is the minimum, is one of the plurality of search points described above, the search point is moved so that the search point with the minimum sum of absolute differences becomes the center of the search pattern in the next operation and the operation described above is executed again. The operation is repeated until the sum of absolute differences of the search point in the center of the search pattern becomes the minimum. According to this known method, the search point in the center of the search pattern is determined as the motion vector when the sum of absolute differences of that search point is the minimum.

This tracking search eliminates the need for searching for all search points in a predetermined search range and therefore reduces the amount of calculation. The tracking search increases the coding efficiency and requires a smaller amount of calculation as the error evaluation value of the search start point is smaller. In this embodiment in which one of the hierarchical MV, accumulation MVs, and calculated MV, whichever gives the minimum error evaluation value point, is used as the search start point, the error evaluation value for the search start point is smaller and therefore the tracking search effect is further increased.

The motion vector determination/output unit 108 receives the search points and the error evaluation values stored in the search point/error evaluation value memory 107, detects the search point with the minimum error evaluation value as the minimum error evaluation value point b, and determines the vector, represented by the relative position of the minimum error evaluation value point b and the coding target image in the reference image, as the motion vector. The motion vector determination/output unit 108 outputs the determined motion vector to an external device via an output terminal 109 and, at the same time, stores it in the MV memory 111 as an accumulation MV.

As described above, the motion vector detecting device according to the present invention detects a motion vector, which gives the minimum evaluation value point, from a hierarchical motion vector, accumulation motion vectors, and a calculated motion vector and searches for a motion vector with only the minimum error evaluation value point as the search start point. Thus, as compared with a conventional device that searches for a motion vector with each of a hierarchical motion vector and surrounding motion vectors as the search start point, the motion vector detecting device according to the present invention can reduce the amount of calculation significantly, eliminates a wasteful search by searching for a point with a high possibility of the minimum error evaluation value, and reduces the amount of calculation for a P picture and a B picture without reducing the coding efficiency. This allows the device according to the present invention to reduce the amount of calculation for a P picture as compared with that of a conventional device that checks the MPEG picture type and, if the picture is a B picture, inhibits (or limits) a reference to surrounding blocks and thus suppresses an increase in the amount of calculation for a B picture.

In addition to surrounding MVs that are accumulation MVs, calculated MVs that are calculated from accumulation MVs are used such as the MV of a block within the reference image that is in the position corresponding to the coding target block (that is, a reference image MV), a motion vector calculated based on an already-detected motion vector of a reference image when there are a plurality of reference images (that is, a multi-reference MV), and a predictive motion vector (PMV). This increases the number of candidates for the search start point and reduces the error evaluation value corresponding to the search start point, further increasing the coding efficiency.

When the motion vector search unit performs a tracking search beginning at the search start point, the device according to the present invention uses one of the hierarchical MV, accumulation MVs, and calculated MV, whichever gives the minimum error evaluation value point, as the search start point and thus reduces the error evaluation value corresponding to the search start point. Because the error evaluation value corresponding to the search start point is smaller, the device according to the present invention further enhances the tracking search effect that increases the coding efficiency and reduces the amount of calculation as the error evaluation value corresponding to the search start point gets smaller.

In addition, the device according to the present invention is simple in the configuration because it can use a hierarchical motion vector and accumulation motion vectors similarly as the candidates for the search start point. The device is also simple in the configuration because it does not need to consider the MPEG picture type but can detect a motion vector regardless of whether the picture is a P picture or a B picture.

It should be noted that the present invention is not limited to the embodiment described above. For example, the present invention includes a motion vector detecting program that causes a computer to execute the function of the motion vector detecting device described above. This motion vector detecting program may be read from a recording medium into a computer or read into a computer via a communication network.

More generally, it should be understood that many modifications and adaptations of the invention will become apparent to those skilled in the art and it is intended to encompass such obvious modifications and changes in the scope of the claims appended hereto.

1. A motion vector detecting device for detecting a motion vector so that an error evaluation value between a block of a coding target image and a block of a reference image becomes smaller, said motion vector being required for motion compensation predictive coding of the coding target image that is a moving image, said motion vector indicating a relative positional relation between the blocks, each of said blocks being a two-dimensional pixel aggregate composed of a predetermined number of pixels, said motion vector detecting device comprising:
a hierarchical motion vector calculation unit that detects a motion vector indicating a relative positional relation between the coding target block of the coding target image and the block of the reference image in an image, created from the coding target image and the reference image and having a resolution lower than that of an original image, and decompresses the detected motion vector based on a reduction in the resolution for calculating a hierarchical motion vector;
a search start point determination unit that calculates error evaluation values of at least one of an accumulation motion vector which is a motion vector detected before detecting the motion vector of the coding target block and a calculated motion vector calculated from the accumulation motion vector, and the hierarchical motion vector calculated by said hierarchical motion vector calculation unit, detects a motion vector corresponding to a minimum error evaluation value of the error evaluation values as a first minimum error evaluation value point, and determines the first minimum error evaluation value point as a search start point;
a motion vector search unit that searches for search points in a search range, which is in the reference image and is determined based on the search start point of the coding target block, and error evaluation values corresponding to the search points; and
a motion vector determination/output unit that detects a search point, which is one of the search points searched for by said motion vector search unit and whose error evaluation Value searched for by said motion vector search unit is the minimum, as a second minimum error evaluation value point, determines a vector based on the second minimum error evaluation value point as the motion vector indicating the relative positional relation between the blocks of the coding target image and the reference image, and outputs the motion vector.

2. The motion vector detecting device according to claim 1, wherein said hierarchical motion vector calculation unit creates a reduced image, whose resolution is reduced from that of the original image, from the coding target image and the reference image, detects the motion vector indicating the relative positional relation between the coding target block and the reference image block corresponding with each other in the reduced image, and decompresses the detected motion vector based on a reduction ratio of the reduced image for calculating a motion vector, which corresponds to the original image, as the hierarchical motion vector.

3. The motion vector detecting device according to claim 1, wherein said search start point determination unit calculates an error evaluation value of a motion vector of a surrounding block and the error evaluation value of the hierarchical motion vector calculated by said hierarchical motion vector calculation unit, detects a motion vector corresponding to a minimum of the error evaluation values as the first minimum error evaluation value point, and determines the first minimum error evaluation value point as the search start point, said motion vector of the surrounding block being used as the accumulation motion vector, said surrounding block being adjacent to the coding target block to be coded, the motion vector of said surrounding block being already calculated.

4. The motion vector detecting device according to claim 1, wherein said search start point determination unit calculates the error evaluation value of at least one of a reference image motion vector of a block located spatially at the same position in the reference image as that of the coding target block of the coding target image, a multi-reference motion vector calculated based on an already-detected motion vector of a reference image when there are a plurality of reference images, and a predictive motion vector predicted based on a motion vector of a surrounding block which is adjacent to the coding target block and whose motion vector is already detected and the error evaluation value of the hierarchical motion vector calculated by said hierarchical motion vector calculation unit, detects a motion vector corresponding to a minimum of the error evaluation values as the first minimum error evaluation value point, and determines the first minimum error evaluation value point as the search start point, said calculated motion vector calculated based on the accumulation motion vector including at least one of the reference image motion vector, the multi-reference motion vector, and the predictive motion vector.

5. The motion vector detecting device according to claim 1, wherein said motion vector search unit performs a tracking search which, with a search point in the center of a search pattern within the search range as the search start point determined by the search start point determination unit, calculates the error evaluation values between the coding target block and the reference image block in the corresponding position for the search start point and each of a predetermined number of a plurality of surrounding search points and continues the search for a motion vector by moving the center of the search pattern to a surrounding search point whose error evaluation value is smaller until a search point whose calculated error evaluation value is smallest becomes the search point in the center of the search pattern.

6. A motion vector detecting program for causing a computer to detect a motion vector so that an error evaluation value between a block of a coding target image and a block of a reference image becomes smaller, said motion vector being required for motion compensation predictive coding of the coding target image that is a moving image, said motion vector indicating a relative positional relation between the blocks, each of said blocks being a two-dimensional pixel aggregate composed of a predetermined number of pixels, said motion vector detecting program causing the computer to execute:
a hierarchical motion vector calculation step that detects a motion vector indicating a relative positional relation between the coding target block of the coding target image and the block of the reference image in an image, created from the coding target image and the reference image and having a resolution lower than that of an original image, and decompresses the detected motion vector based on a reduction in the resolution for calculating a hierarchical motion vector;
a search start point determination step that calculates error evaluation values of at least one of an accumulation motion vector and a calculated motion vector calculated from the accumulation motion vector, and the hierarchical motion vector calculated by said hierarchical motion vector calculation step, detects a motion vector corresponding to a minimum error evaluation value of the error evaluation values as a first minimum error evaluation value point, and determines the first minimum error evaluation value point as a search start point, said accumulation motion vector being a motion vector detected before detecting the motion vector of the coding target block;
a motion vector search step that searches for search points in a search range, which is in the reference image and is determined based on the search start point of the coding target block, and error evaluation values corresponding to the search points; and
a motion vector determination/output step that detects a search point, which is one of the search points searched for by said motion vector search step and whose error evaluation value searched for by said motion vector search step is the minimum, as a second minimum error evaluation value point, determines a vector based on the second minimum error evaluation value point as the motion vector indicating the relative positional relation between the blocks of the coding target image and the reference image, and outputs the motion vector.
